(19) United States
(12) Patent Application Publication
(10) Pub. No.: US 2021/0340030 A1
(43) Pub. Date: Nov. 4, 2021

(54) DESALINATION DISTILLATION COMMERCIAL POWER AND WATER GENERATION USING HHO ELECTROLYSIS AND STEAM BOILER

(71) Applicant: Pedro Norlito Ibanez, Temecula, CA (US)

(72) Inventor: Pedro Norlito Ibanez, Temecula, CA (US)

(21) Appl. No.: 17/322,938

(22) Filed: Jun. 9, 2021

Related U.S. Application Data
(63) Continuation-in-part of application No. PCT/US21/32761.

(51) Int. Cl. C02F 1/44; F01K 25/00; F01K 7/44; C25B 1/04

(52) U.S. Cl. CPC C02F 1/447; F01K 25/005; C02F 2103/08; C25B 1/04; F01K 7/44

(57) ABSTRACT

This Desalination Distillation Commercial Power Generation invention is powered by Hydrogen and Oxygen produced thru electrolysis. Present art desalination plants either use desalination distillation Or Reverse Osmosis. Both methods require large amounts of electrical power. This invention uses desalination distillation. In this method, oceanwater is boiled and steamed then cooled down back to clean water while in the process producing electricity.

Electrolysis is the process of breaking water (H2O) to its molecular atoms of Hydrogen gas and Oxygen gas. Using Clean Purified water (which is similar to Distilled Water) is the most efficient way to produce hydrogen. This invention will produce Clean Water and generate commercial electricity.

This Desalination Distillation Commercial Power Generation invention is powered by Hydrogen and Oxygen produced thru electrolysis. Present art desalination plants either use desalination distillation Or Reverse Osmosis. Both methods require large amounts of electrical power. This invention uses desalination distillation. In this method, oceanwater is boiled and steamed then cooled down back to liquid and Clean Water is produced. When oceanwater is boiled the salt part of the liquid is left behind in the tank and eventually must be removed. This invention will have automatic device that will empty the Boiler tank, open a Panel on the side of the tank and scoop out the residual salt, then seal the tank again and refill with oceanwater.

Distillation follows after oceanwater has boiled. Distillation can be easily compared to the normal everyday car's radiator system. The car needs to regulate the temperature of the engine for the car to function normally. The car does this by having water or radiator fluid flowing around the engine and in so doing this liquid is heated and boiled. This liquid around the engine must be cooled down. The boiled liquid (steam) will travel from the engine to the car's radiator using tubes that total several meters long. These tubes that contain the steam are exposed to the atmosphere while the car engine is running. Exposing the steam to the atmosphere will start to lower the temperature of the Steam and this is helped along by a blower fan that forces more cooler air around the tubes. This process will return the steam to liquid state, and this cooler liquid will be recycled around the engine, and the process starts all over again.

The main difference between the car's radiator and the desalination plant is that the cooled liquid is Not returned to an engine. The cooled water is now Clean Water that can be used by the Electrolyzer. Clean distilled water is the most efficient eLectrolyte for the Electrolyzer.

Electrolysis is the process of breaking water (H2O) to its molecular atoms of Hydrogen gas and Oxygen gas. Using Clean Purified water (which is similar to Distilled Water) is the most efficient way to produce hydrogen. This invention will produce Clean Water.

Because hydrogen and oxygen are clean breathable elements, there is the bonus addition of no adverse affect to the environment. This is excellent Contrast to present day Desalination plants that may derive its electrical input from Dirty Coal or expensive Oil.

One problem with using oceanwater as the electrolyte for this electrolysis is corrosion from chlorine found in seawater that eventually will corrode the hydrogen terminal and stop the process. There are now devices and catalysts available in the market that stops this corrosion and makes seawater as a viable electrolyte. This invention needs no outside devices or catalyst because it produces clean water.

It is important to note that there are available in 2020 electrolysis machines (called Electrolyzer) in particular EBay.com, Kit electrolyzers 110V that produce anywhere from 75 Liters per Hour of hydrogen to as much as 150 Liters per Hour. A 1000 gallons Steam Boiler Tank will need about 150 LPH of Hydrogen gas to boil the oceanwater inside Boiler Tank (Pressure Vessel).

The Clean Water produced will be fed into the water intake of the Electrolyzer. Clean water used as electrolyte by the Electrolyzer becomes depleted as the water is broken down and Hydrogengas and Oxygengas are produced.

Hydrogen Gas Distributor Circle. As the name implies it is a round tube that has holes to expel the hydrogen gas as it burns. This is comparable to normal household stove that uses natural gas or propane. The hydrogen gas comes out of the Distributor Circle and is burned to heat the Steam Boiler.

An electrolysis machine or Electrolyzer needs electricity to produce Hydrogen. There are a few ways to provide the electrical input to the Electrolyzer.
1. Solar Panel with enough wattage.
2. Wind Mill power generators are more efficient than solar power since there are areas in the country that provide enough wind push 24 hours per day, day or night.
3. This invention will provide electrical input to its Electrolyzer from a 5000 watt 110V/220V Portable Gasoline Generator.

Electrolyzer electrical input will come from 5000 Watt 110V/220V Portable Gasoline Generator that can easily be purchased from your local Home Depot. One 150 LPH hydrogen Electrolyzer will need about 300 watts according to Label Specifications. With one 150 LPH hydrogen Electrolyzer needed for a 1000 gallons Steam Boiler, one 5000 Watt portable generator will be more than sufficient. With inventor's personal experience a 5000 Watt 110V/220V gasoline generator can power two 60 watt light bulbs and one 500 watt 8000 BTU small air-conditioner 200 sqft room for 24 hours using about 15 gallons of gasoline. There are available 8000 watt portable gasoline generator.

The US Patent Office does not require an invention to be cost effective, but certain countries in Europe and Japan require cost effectiveness. This invention is cost effective. At present March 2021 average gasoline price in California of $4 per gallon, it would cost about $60 per day to operate a 1000 gallon Steam Boiler Desalination Distillation Power Generation system to include one 1200 watt ½ HP water pump and two 100 watt blower fan motors.

This 1000 gallon Steam Boiler will empty out into clean water in about six to eight hours depending on the demands of the Electrolyzer, and Dynamo, so therefore new seawater needs to be pumped into the boiler Tank by the ½ HP 700 GPH water pump. Clean water output can be adjusted by lowering Hydrogen gas output burn.

### HOW THE DESALINATION DISTILLATION COMMERCIAL POWER GENERATION SYSTEM WORKS

Steam Boiler should start with a full 1000 gallons of COLD SEAWATER. As soon as Portable Generator is turned on, Electrolyzer will start to produce Hydrogen which is lit and burned to provide heat to Steam Boiler. Hydrogen gas comes out of Hydrogen Distributor Circle. At the same time Blower Fan turns on and Water pump starts feeding oceanwater Only to the Sprinklers that will cool down the Steam. Water pump does not start pumping oceanwater into Boiler Tank until Water Level Switch turns on when oceanwater inside boiler Tank reaches a certain low level.

As oceanwater inside Steam Boiler reaches boiling temperature, steam can only Exit out of the Boiler Tank Spout and then this steam Must Turn the Cup Rotators, as the Cup Rotators can only turn One Way. As the Steam escapes it turns the Cup Rotators which is sealed inside the a cup Rotator Box. The distance between the top and side edge of the Cup Rotators and the walls of Cup Rotator Box is very small, about 500th of an inch to prevent the steam from escaping Without Turning the Cup Rotators, which can only turn One away. The Cup Rotators is connected by the Dynamo Shaft to the Dynamo.

Dynamos are copper coils wound around a magnet which creates a Magnetic Field. When this magnetic field is disturbed by turning the copper coils Or the magnet, electricity is produced. Large Dynamoes that turn at high speed can produce megawatts of commercial electricity.

A simple example of a dynamo producing electricity is a Bicycle Dynamo. As the biker turns the pedal, the bike dynamo turns and produces enough electricity to light the bike headlight. In comparison Large River dams such as Hoover Dam drops tons of water into large pipes that have wheels that are comparable to Cup Rotators of this Invention. Tons of water force these giant water cup rotators, which are connected to Large Dynamoes to turn and produce commercial electricity.

After the Steam gets pass the Cup Rotators, they go into the Cooling Coils. Steam is now being cooled by Oceanwater Sprinklers and Blower Fans. STEAM returns to CLEAN LIQUID WATER STATE. Some of this Clean Water will go to Electrolyzer to become electrolyte, to produce more hydrogen gas. Safety is assured by Pressure Relief Valve which releases pressure at 165 PSI for a 200 PSI STEAM BOILER. The cycle repeats itself as long as there is gasoline in the portable generator.

What is claimed:

ONE Methods, Combinations, Configurations and Similar Apparatus that are safely mechanically and electrically merged together to Produce and/or results in Commercial Power and commercial amounts of clean water, and/Or escalating amounts, by using (HHO) hydrogen and/or oxygen from electrolysis, desalination and distillation, using Steam Boilers, using gears or Cup Rotators, that rotate and turn an electrical Dynamo, such rotations are what create electrical output.
Commercial electrical power is measured in megawatts while commercial clean water is measured in Cubic Hectares.
Electrolysis is the process of breaking water (H2O) to its molecular atoms of Hydrogen gas and Oxygen gas. Using Clean Purified water (which is similar to Distilled Water) is the most efficient way to produce hydrogen. This invention will produce Clean Water and Commercial Power.
It is important to note that there are available in year 2020 electrolysis machines (called Electrolyzer) in particular EBay.com, Kit electrolyzers 110V that produce anywhere from 75 LPH (Liters per Hour) of hydrogen to as much as 150 Liters per Hour. A 1000 gallons Steam Boiler Tank will need about 150 LPH of Hydrogen gas to boil the oceanwater inside Boiler Tank (Pressure Vessel).
The Clean Water produced will be fed into the water intake of the Electrolyzer. Clean water used as electrolyte by the Electrolyzer becomes depleted as the water is broken down and Hydrogengas and Oxygengas are produced.
Desalination is producing clean water from ocean water by boiling saltwater. When saltwater is boiled, residual salt crystals are left behind in the boiling container or Steam Boiler. This invention will have an automatic device that will empty the Boiler tank, open a Panel on the side of the tank and scoop out the residual salt, then seal the tank again and refill with oceanwater.
Distillation is the cooling down of Steam that results in production of clean water. Clean water means that biological toxins and salt crystals are removed by boiling. Distillation can be compared to a car engine. Distillation follows after oceanwater has boiled. Distillation can be easily compared to the normal everyday car's radiator system. The car needs to regulate the temperature of the engine for the car to function normally. The car does this by having water or radiator fluid flowing around the engine and in so doing this liquid is heated and boiled. This liquid around the engine must be cooled down. The boiled liquid (steam) will travel from the engine to the car's radiator using tubes that total several meters long. These tubes that contain the steam are exposed to the atmosphere while the car engine is running. Exposing the steam to the atmosphere will start to lower the temperature of the Steam and this is helped along by a blower fan that forces cooler air around the tubes. This process will return the steam to liquid state, and
this cooler liquid will be recycled around the engine, and the process starts all over again.
The main difference between the car's radiator and the desalination plant is that the cooled liquid is Not returned to an engine. The cooled water is now Clean Water that can be used by the Electrolyzer or for agricultural and residential use. Clean distilled water is the most efficient eLectrolyte for the Electrolyzer.
What is Unique and innovative about this Invention is the Merging together of all this Old concepts and the use primarily of Hydrogen, which is the most abundant element on this planet. Using hydrogen thereby makes this invention Environmentally Friendly as there is zero carbon emissions from this invention. This invention believes that Wind Mills Power Input is a very cost-effective electrical input to the Electrolyzer.
The Electrolyzer of this Invention requires 110V household electrical input which can be provided by 5000 watt 110V PGG (portable gasoline generator) which is available at many local hardware stores such as Home Depot{C}. This invention continues to provide Electrical Output and Clean Water as long as there is gasoline in the PGG.

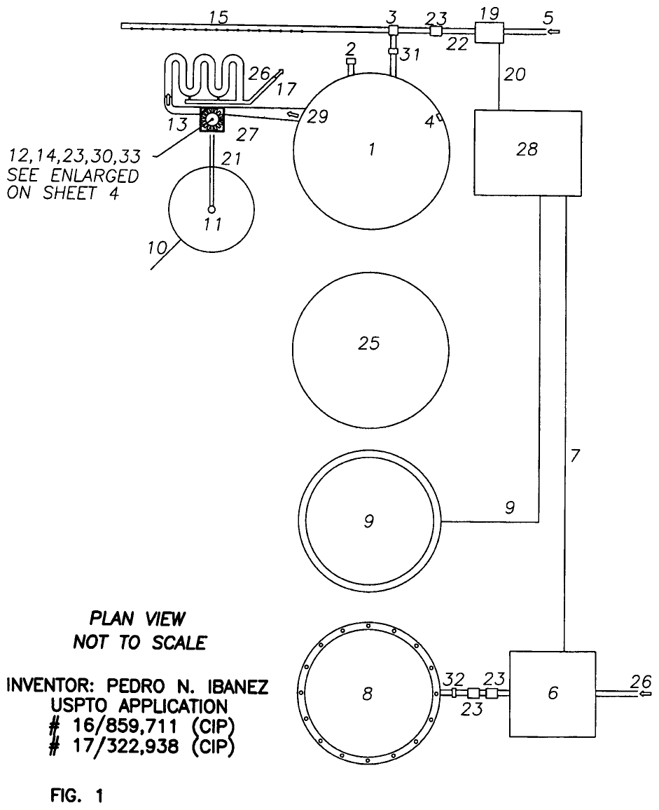

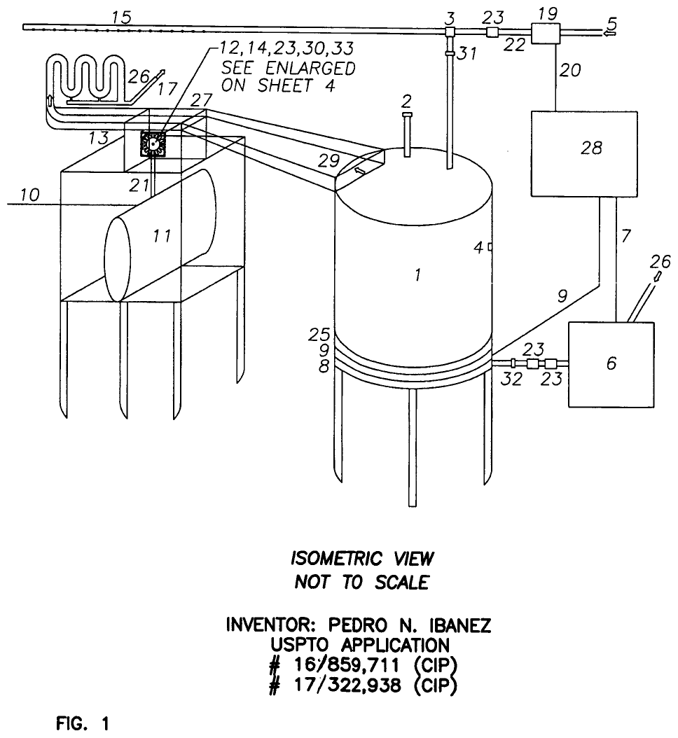

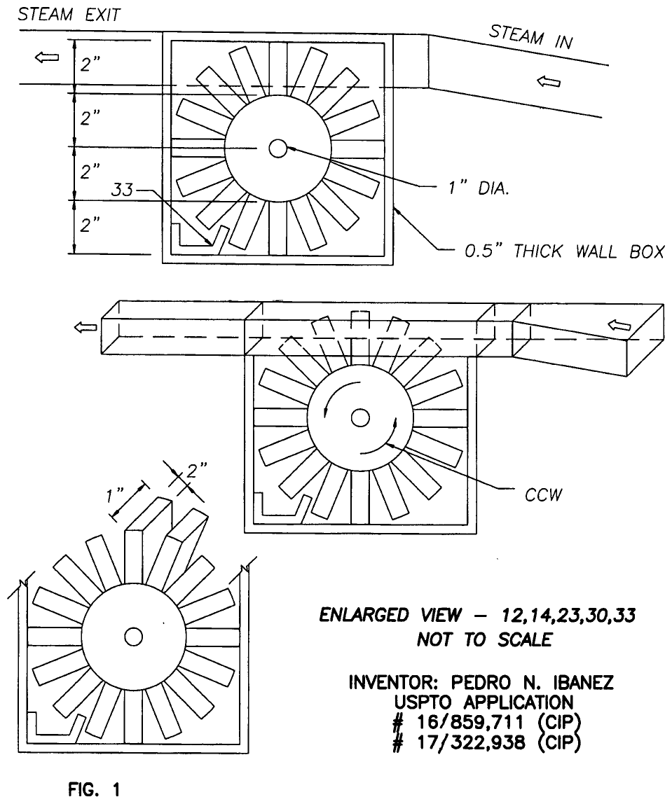

TWO Refer to following as attachments to Claim Two:
FIG. 1. DRAWING DIAGRAM OF HHO DESALINATION DISTILLATION COMMERCIAL POWER GENERATION AND DESCRIPTION OF PARTS.
HOW THE DESALINATION DISTILLATION COMMERCIAL POWER GENERATION AND CLEAN WATER PRODUCTION SYSTEM WORKS.
Steam Boiler should start with a full 1000 gallons of COLD SEAWATER. As soon as Portable Generator (PGG) is turned on, Electrolyzer will start to produce Hydrogen which is lit and burned to provide heat to Steam Boiler. Hydrogen gas comes out of Hydrogen Distributor Circle. At the same time Blower Fan turns on and Water pump starts feeding oceanwater Only to the Sprinklers that will cool down the Steam. Water pump does not start pumping oceanwater into Boiler Tank until Water Level Switch turns on when oceanwater inside boiler Tank reaches a certain low level.
As oceanwater inside Steam Boiler reaches boiling temperature, steam can only Exit out of the Boiler Tank Spout and then this steam Must Turn the Cup Rotators, as the Cup Rotators can only turn One Way. Cup Rotators are any such apparatus that limit the escape of steam from the Steam Boiler. In this apparatus, Steam must turn the Cup Rotators in order to escape out of the Steam Boiler. As the Steam escapes it turns the Cup Rotators which is sealed inside the a cup Rotator Box. The distance between the top and side edge of the Cup Rotators and the walls of Cup Rotator Box is very small, about 500th of an inch to prevent the steam from escaping Without Turning the Cup Rotators, which can only turn One away. The Cup Rotators is connected by the Dynamo Shaft to the Dynamo.
Dynamos are copper coils wound around a magnet which creates a Magnetic Field. When this magnetic field is disturbed by turning the copper coils Or the magnet, electricity is produced. Large Dynamoes that turn at high speed can produce megawatts of commercial electricity.
A simple example of a dynamo producing electricity is a Bicycle Dynamo. As the biker turns the pedal, the bike dynamo turns and produces enough electricity to light the bike headlight. In comparison Large River dams such as Hoover Dam drops tons of water into large pipes that have wheels that are comparable to Cup Rotators of this Invention. Tons of water force these giant water cup rotators, which are connected to Large Dynamoes to turn and produce commercial electricity.
After the Steam gets pass the Cup Rotators, they go into the Cooling Coils. Steam is now being cooled by Oceanwater Sprinklers and Blower Fans. STEAM returns to CLEAN LIQUID WATER STATE. Some of this Clean Water will go to Electrolyzer to become electrolyte, to produce more hydrogen gas. Safety is assured by Pressure Relief Valve which releases pressure at 165 PSI for a 200 PSI STEAM BOILER. The cycle repeats itself as long as there is gasoline in the portable generator.

THREE Secondary power to heat Steam Boiler can come from Electric Heater Coils. These heater coils are similar to heater coils of most normal household electrical stoves. These Electric Heater Coils acquire electrical input from PGG. In this secondary power condition the Electric Heater Coils take the place the Hydrogen Electrolyzer. But in this Mode, environmental friendliness is Lost, but can be regained if the community Power Grid is powered by Hydrogen.!!
